(19) United States
(12) Patent Application Publication
(10) Pub. No.: US 2023/0178865 A1
(43) Pub. Date: Jun. 8, 2023

(54) BATTERY CELL, BATTERY UNIT AND BATTERY CLUSTER

(71) Applicants: Microvast Power Systems Co., Ltd., Huzhou (CN); Microvast, Inc., Stafford, TX (US)

(72) Inventors: Yang WU, Honolulu, HI (US); Ningqiang XIAO, Huzhou (CN); Heng ZHAO, Huzhou (CN); Wenjuan Liu MATTIS, Longwood, FL (US)

(73) Assignees: Microvast Power Systems Co., Ltd., Huzhou (CN); Microvast, Inc., Stafford, TX (US)

(21) Appl. No.: 17/544,972

(22) Filed: Dec. 8, 2021

(51) Int. Cl. H01M 50/627; H01M 10/613; H01M 10/6556; H01M 10/48; H01M 50/209; H01M 10/6568

(52) U.S. Cl. CPC H01M 50/627; H01M 10/613; H01M 10/6556; H01M 10/48; H01M 50/209; H01M 10/6568; H01M 2200/20

(57) ABSTRACT

A battery cell is provided. The battery cell is provided with circulation elements for circulating between inside and outside of the battery cell, and the circulation elements are connected with the battery cell. Substances inside the battery cell are capable of being discharged out of the battery cell through the circulation elements, and substances outside the battery cell also capable of entering the interior of the battery cell through the circulation elements. The battery cell is carried with its own circulation elements, the battery cell is not injected with electrolyte during production, transportation and assembly, and the electrolyte is injected into the battery cell after the installation of the battery cluster. Therefore, the battery cluster is not charged during transportation and installation of the battery cluster, to eliminate the safety risk of the battery cluster during transportation and installation. A battery unit and a battery cluster are also provided.

### TECHNICAL FIELD

The present invention relates to the technical field of batteries, and in particular, to a battery cell, a battery unit and a battery cluster.

### BACKGROUND OF THE INVENTION

With the development of electronic technology, lithium-ion battery has been widely used because of its high specific power, long cycle life, good safety performance and less pollution. At present, large-scale energy storage system is generally composed of multiple battery clusters which are connected in parallel to increase the capacity of the energy storage system. The battery cluster is usually composed of a high-voltage control box and a plurality of battery units connected in series. The plurality of battery units and the high-voltage control box are integrated on a battery cluster bracket, and the battery unit is formed by a plurality of battery cells connected in series or in parallel.

The battery cluster is generally assembled on site after being transported to the destination by battery units. The battery unit has been charged during transportation and assembly. The battery cluster of the existing design has the following disadvantages:
(1) The battery unit is transported after being charged, with high transportation risk, strict transportation standards and high transportation cost;
(2) When the battery units are assembled into a battery cluster on site, the battery units are assembled with electricity, with high voltage and high installation risk;
(3) The energy storage system needs multiple battery clusters connected in parallel, with many parallel branches, high requirements for the consistency of battery cells, a large number of high-voltage control boxes, a large number of high-voltage electrical parts, low system reliability and high cost;
(4) The battery cells are firstly assembled into a battery unit, and then the battery units are assembled into a battery cluster. The battery cluster requires many structural parts, which greatly increases the weight of the battery cluster, reduces the energy density of the battery cluster and greatly increases the cost.

Meanwhile, thermal runaway is an important concern in the design of lithium-ion battery. The thermal runaway of battery generally goes through the following four stages:
(1) The battery cell is damaged, and the temperature and pressure of the battery cell rise;
(2) With the increase of temperature and pressure of the battery cell, flammable gas is generated and discharged from the battery cell;
(3) The temperature of the battery cell rises rapidly and the battery cell undergoes thermal runaway. The heat of the battery cell under thermal runaway is quickly transferred to other adjacent battery cells, resulting in the risk of thermal runaway of other battery cells;
(4) The battery cell starts to catch fire after the thermal runaway. The fire will quickly spread to adjacent battery cells and become uncontrollable.

In these four stages, the earlier the battery problem is detected, the easier it is to quickly control the risk and cause the least loss. At present, the mainstream energy storage system generally controls the thermal runaway in the fourth stage: the energy storage system is equipped with a fire protection system, which includes smoke alarm system and gas fire-extinguishing system. Only after the thermal runaway fire occurs, the smoke alarm system after detecting smoke of the fire will issue an instruction to make the gas fire-extinguishing system start fire extinguishing. Therefore, the existing fire-extinguishing system will intervene late when the thermal runaway occurs, the effect is poor, and the fire-extinguishing is incomplete, which will often lead to greater fires.

### SUMMARY OF THE INVENTION

The object of the present invention is to provide a battery cell, a battery unit, a battery cluster, a battery cell liquid injection method, and a battery cluster liquid injection method. The battery cell is carried with its own circulation elements, electrolyte is not injected into the battery cell during production, transportation and assembly, and liquid is injected into the battery cell after the installation of the battery cluster, such that the battery cluster is not charged during transportation and installation of the battery cluster, so as to eliminate the safety risk of the battery cluster during transportation and installation.

An embodiment of the present invention provides a battery cell, wherein the battery cell is provided with circulation elements for circulating between inside and outside of the battery cell, and the circulation elements are connected with the battery cell; substances inside the battery cell are capable of being discharged out of the battery cell through the circulation elements, and substances outside the battery cell are also capable of entering an interior of the battery cell through the circulation elements.

In one embodiment, the circulation elements include an inlet element capable of allowing substances outside the battery cell to enter the battery cell and an outlet element capable of discharging substances inside the battery cell to an exterior of the battery cell, both the inlet element and the outlet element are connected with the battery cell.

In one embodiment, the inlet element and the outlet element are respectively connected to different positions on the battery cell.

In one embodiment, the inlet element includes a cell inlet pipe, the outlet element includes a cell outlet pipe, and the cell inlet pipe and the cell outlet pipe are respectively connected to different positions on the battery cell.

In one embodiment, the cell inlet pipe is connected to the bottom position of the battery cell, and the cell outlet pipe is connected to the top position of the battery cell.

In one embodiment, an on-off valve and/or a one-way valve are arranged on the cell inlet pipe and/or the cell outlet pipe.

In one embodiment, a one-way valve is arranged on the cell inlet pipe and/or the cell outlet pipe; the one-way valve is arranged on the cell inlet pipe close to the battery cell, and/or the one-way valve is arranged on the cell outlet pipe close to the battery cell.

In one embodiment, a one-way valve is arranged on the cell inlet pipe and/or the cell outlet pipe; the one-way valve is connected with the battery cell through a hose.

In one embodiment, at least a portion of the cell inlet pipe is hose, and/or at least a portion of the cell outlet pipe is hose.

In one embodiment, the circulation elements further include external pipes, the external pipes include an external inlet pipe and an external outlet pipe, the external inlet pipe is connected with the cell inlet pipe, and the external outlet pipe is connected with the cell outlet pipe.

In one embodiment, the external outlet pipe is provided with a pressure sensor.

In one embodiment, the external inlet pipe and the external outlet pipe are each provided with an openable valve.

In one embodiment, the external inlet pipe is arranged at the bottom of the battery cell, and the external outlet pipe is arranged at the top of the battery cell.

Another embodiment of the present invention provides a battery unit including at least one battery cell described above, wherein the circulation elements include an inlet element and an outlet element, the inlet element includes a cell inlet pipe, the outlet element includes a cell outlet pipe, and the cell inlet pipe and the cell outlet pipe are respectively connected to different positions on the battery cell; the circulation elements further include external pipes, the external pipes include an external inlet pipe and an external outlet pipe, the external inlet pipe is connected with the cell inlet pipe, and the external outlet pipe is connected with the cell outlet pipe.

Another embodiment of the present invention provides a battery unit including a plurality of battery cells described above, wherein the circulation elements include an inlet element and an outlet element, the inlet element includes a cell inlet pipe, the outlet element includes a cell outlet pipe, and the cell inlet pipe and the cell outlet pipe are respectively connected to different positions on each battery cell; the circulation elements further include external pipes, the external pipes include an external inlet pipe and an external outlet pipe, the external inlet pipe is connected with the cell inlet pipe, and the external outlet pipe is connected with the cell outlet pipe; the battery unit further includes a cell inlet main pipe and a cell outlet main pipe, the cell inlet pipes on the plurality of battery cells are firstly collectively connected to the cell inlet main pipe and then connected to the external inlet pipe, and the cell outlet pipes on the plurality of battery cells are firstly collectively connected to the main outlet pipe and then connected to the external outlet pipe.

In one embodiment, the battery unit further includes a protection bracket and a support bracket, the protection bracket and the support bracket are respectively arranged at opposite ends of each battery cell, the cell outlet pipe is fixed on the protection bracket, and the cell inlet pipe is fixed on the support bracket.

In one embodiment, the protection bracket is provided with at least one first receiving groove, the support bracket is provided with at least one second receiving groove, and the opposite ends of each battery cell are respectively located in a corresponding first receiving groove and a corresponding second receiving groove.

In one embodiment, the protection bracket includes a protection plate and a protection cover, the protection plate is connected with the battery cell, the protection cover is connected with the protection plate and is located on one side of the protection plate away from the battery cell, and the first receiving groove is arranged in the protection plate, the cell outlet pipe is fixed on the protection cover.

In one embodiment, the support bracket includes a support tray and a fixing frame, the support tray is connected with the battery cell, the fixing frame is connected with the support tray and located on one side of the support tray away from the battery cell, and the second receiving groove is arranged in the support tray, the cell inlet pipe is fixed on the fixing frame.

Another embodiment of the present invention provides a battery cluster including at least one battery unit described above.

In one embodiment, the battery cluster further includes a battery cluster bracket, and the battery unit is arranged on the battery cluster bracket.

In one embodiment, the battery cluster bracket includes a bottom support frame and a side connection frame, and the side connection frame is connected with the bottom support frame and arranged on at least one side of the battery cluster, the support bracket of the battery unit is connected with the bottom support frame, and the protection bracket of the battery unit is connected with the side connection frame.

In one embodiment, the number of the side connection frame is two, and the two side connection frames are respectively arranged on the opposite sides of the battery cluster; the battery cluster bracket further includes two side connection beams arranged on the other opposite sides of the battery cluster, and both ends of each side connection beam are respectively connected with the two side connection frames.

Another embodiment of the present invention provides a battery cell liquid injection method for injecting electrolyte into the interior of the battery cell. The method includes:
providing circulation elements on the battery cell, wherein the circulation elements include an inlet element and an outlet element, the inlet element includes a cell inlet pipe, the outlet element includes a cell outlet pipe, and the cell inlet pipe and the cell outlet pipe are respectively connected to different positions on the battery cell;
connecting the liquid injection device with the cell inlet pipe and the cell outlet pipe, using the liquid injection device to inject electrolyte into the interior of the battery cell through the cell inlet pipe, and discharging the air and excess electrolyte inside the battery cell back into the liquid injection device through the cell outlet pipe; and
disconnecting the liquid injection device from the cell inlet pipe and the cell outlet pipe after the electrolyte injection is completed.

Another embodiment of the present invention provides a battery cell liquid injection method for injecting coolant into the interior of a battery cell in which thermal runaway occurs. The method includes:
providing circulation elements on the battery cell, wherein the circulation elements include an inlet element and an outlet element, the inlet element includes a cell inlet pipe, the outlet element includes a cell outlet pipe, and the cell inlet pipe and the cell outlet pipe are respectively connected to different positions on the battery cell;
connecting the external fire-extinguishing pipe with the cell inlet pipe and the cell outlet pipe, using the external fire-extinguishing pipe to inject coolant into the interior of the battery cell through the cell inlet pipe, and discharging the coolant inside the battery cell back into the external fire-extinguishing pipe through the cell outlet pipe, so as to continuously cool the battery cell.

In one embodiment, a one-way valve is arranged on the cell inlet pipe and/or the cell outlet pipe. The method further includes:
using the one-way valve to control the one-way flow of the electrolyte or the coolant when the electrolyte or the coolant is injected into the interior of the battery cell.

Another embodiment of the present invention provides a battery cluster liquid injection method for injecting electrolyte into the interior of the battery cells. The method includes:
assembling at least one battery unit together to form a battery cluster, wherein the battery unit includes at least one battery cell, the battery cell is provided with circulation elements, the circulation elements include an inlet element and an outlet element, the inlet element includes a cell inlet pipe, the outlet element includes a cell outlet pipe, the cell inlet pipe and the cell outlet pipe are respectively connected to different positions on the battery cell; the circulation elements further include external pipes, the external pipes include an external inlet pipe and an external outlet pipe, the external inlet pipe is connected with the cell inlet pipe, and the external outlet pipe is connected with the cell outlet pipe;
connecting the liquid injection device with the external inlet pipe and the external outlet pipe, using the liquid injection device to inject electrolyte into the interior of each battery cell in each battery unit through the external inlet pipe and the cell inlet pipe in sequence, and discharging the air and excess electrolyte inside the battery cell back into the liquid injection device through the cell outlet pipe and the external outlet pipe in sequence; and
disconnecting the liquid injection device from the external inlet pipe and the external outlet pipe after the electrolyte injection is completed.

Another embodiment of the present invention provides a battery cluster liquid injection method for injecting coolant into the interior of a battery cell in which thermal runaway occurs. The method includes:
assembling at least one battery unit together to form a battery cluster, wherein the battery unit includes at least one battery cell, the battery cell is provided with circulation elements, the circulation elements include an inlet element and an outlet element, the inlet element includes a cell inlet pipe, the outlet element includes a cell outlet pipe, the cell inlet pipe and the cell outlet pipe are respectively connected to different positions on the battery cell; the circulation elements further include external pipes, the external pipes include an external inlet pipe and an external outlet pipe, the external inlet pipe is connected with the cell inlet pipe, and the external outlet pipe is connected with the cell outlet pipe;
connecting the external fire-extinguishing pipe with the external inlet pipe and the external outlet pipe, using the external fire-extinguishing pipe to inject coolant into the interior of the battery cell with thermal runaway through the external inlet pipe and the cell inlet pipe in sequence, and discharging the coolant inside the battery cell with thermal runaway back into the external fire-extinguishing pipe through the cell outlet pipe and the external outlet pipe in sequence, so as to continuously cool the battery cell with thermal runaway.

In one embodiment, a one-way valve is arranged on the cell inlet pipe and/or the cell outlet pipe. The method further includes:
using the one-way valve to control the one-way flow of the electrolyte or the coolant when the electrolyte or the coolant is injected into the interior of the battery cell.

The battery cell provided by the present invention has the following advantages:
(1) The battery cell is carried with its own circulation elements, electrolyte is not injected into the battery cell in the process of production, transportation and assembly, and the liquid is injected into the battery cell after the installation of the battery cluster. Therefore, it is not charged during transportation and installation of the battery cell, battery unit or battery cluster, so as to eliminate the safety risks in the process of transportation and installation;
(2) The battery cell is carried with its own circulation elements, and external substances can be added into the interior of the battery cell as needed. For example, with the long-term cycles of the battery, the electrolyte is gradually consumed, and the remaining electrolyte is not enough to maintain the charging and discharging process of the battery cell, thereby affecting the capacity and service life of the power battery, the electrolyte can be filled through the incorporated circulation elements at any time, so as to maintain the good performance of the battery cell, improve the service life of the battery cell, solve the problem that the battery cell cannot be maintained, and facilitate the later maintenance and management of the battery cell. Further, when thermal runaway occurs in the battery cell, fire-extinguishing agent, coolant and other substances can be injected into the battery cell through the circulation elements to extinguish the fire and reduce the internal temperature of the battery cell, so as to improve the safety performance of the battery cell;
(3) The battery cell is carried with its own circulation elements, the battery cell can discharge internal substances outward as required. For example, when the battery cell generates gas after long-term cycles, resulting in battery inflation, it can discharge gas to the outside through its own circulation elements at any time, so as to maintain the good performance of the battery cell, improve the service life of the battery cell, solve the problem that the battery cell cannot be maintained, and facilitate the later maintenance and management of the battery cell.

### BRIEF DESCRIPTION OF THE DRAWINGS

FIG. 1 is a three-dimensional structural schematic view of a battery unit according to an embodiment of the present invention.

FIG. 2 is a bottom view of FIG. 1.

FIG. 3 is a three-dimensional structural schematic view of the protection bracket in FIG. 1.

FIG. 4 is a bottom view of FIG. 3.

FIG. 5 is a three-dimensional structural schematic view of the support bracket in FIG. 1.

FIG. 6 is a bottom view of FIG. 5.

FIG. 7 is a three-dimensional structural schematic view of a battery cluster according to an embodiment of the present invention.

FIG. 8 is an exploded view of FIG. 7.

FIG. 9 is a block diagram of the flowing direction of the electrolyte when the electrolyte is injected into the battery cell according to an embodiment of the present invention.

FIG. 10 is a block diagram of the flowing direction of the coolant when the coolant is injected into the battery cell according to an embodiment of the present invention.

FIG. 11 is a three-dimensional structural schematic view of a battery cluster according to another embodiment of the present invention.

In the figures: 1-battery unit, 11-battery cell, 111-liquid hole, 12-protection bracket, 121-first receiving groove, 122-protection plate, 123-protection cover, 124-first through hole, 13-support bracket, 131-second receiving groove, 132-support tray, 133-fixing frame, 134-second through hole, 135-receiving chamber, 141-cell inlet pipe, 142-cell outlet pipe, 143-cell inlet main pipe, 144-cell outlet main pipe, 145-on-off valve, 15-external pipe, 151-external inlet pipe, 152-external outlet pipe, 153-valve, 154-first plug, 155-first external branch pipe, 156-second external branch pipe, 157-pressure sensor, 15a-interface, 16-temperature and voltage detecting cable, 17-one-way valve, 18-first electrical connector, 191-second plug, 192-fixing buckle, 2-battery cluster bracket, 21-bottom support frame, 22-side connection frame, 23-side connection beam, 3-pipe clamp, 4-second electrical connector, 5-battery management unit, 51-mounting frame, 6-insulating column, 7-liquid injection device, 8-external fire-extinguishing pipe.

### DETAILED DESCRIPTION OF PREFERRED EMBODIMENTS

Specific embodiments of the present invention will be described in further detail below in conjunction with the accompanying drawings. The following embodiments are used to illustrate the present invention, but are not used to limit the scope of the present invention.

The terms “first”, “second”, “third”, “fourth” and the like (if any) involved in the description and claims of the present invention are used to distinguish similar objects, and are not used to describe a specific order or sequence.

The spatial terms “up”, “down”, “left”, “right”, “front”, “back”, “top”, “bottom” and the like (if any) involved in the description and claims of the present invention are defined by the positions of the structures in the figures and the positions between the structures, for the clarity and convenience of expressing the technical solution. It should be understood that the use of these spatial terms should not limit the scope of the present invention.

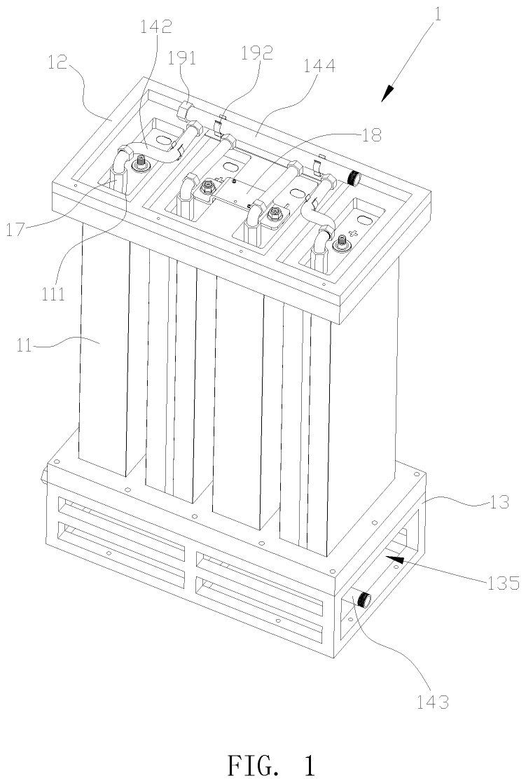

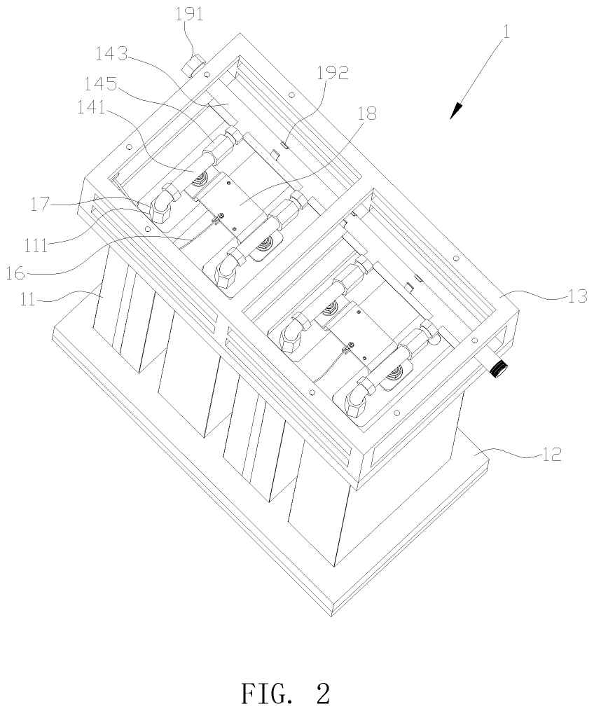

As shown in FIG. 1 and FIG. 2, the embodiment of the present invention provides a battery cell 11. The battery cell 11 is provided with circulation elements for circulating between inside and outside of the battery cell 11, and the circulation elements are connected with the battery cell 11. Substances inside the battery cell 11 can be discharged out of the battery cell 11 through the circulation elements, and substances outside the battery cell 11 can also enter the interior of the battery cell 11 through the circulation elements.

Specifically, the functions of the circulation elements can be as follows:
(1) When injecting electrolyte into the battery cell 11, the electrolyte can enter the battery cell 11 through the circulation elements, and the air and excess electrolyte inside the battery cell 11 can be discharged out of the battery cell 11 through the circulation elements;
(2) When a side reaction occurs inside the battery cell 11 to produce gas, the generated gas can be discharged out of the battery cell 11 through the circulation elements;
(3) When the battery cell 11 is on fire due to thermal runaway, fire-extinguishing agent or coolant can be injected into the battery cell 11 through the circulation elements, while the heat, flame and combustible gas generated inside the battery cell 11 can be discharged out of the battery cell 11 through the circulation elements.

Of course, the circulation elements can also be used for other purposes.

In one embodiment, the circulation elements include an inlet element capable of allowing substances outside the battery cell 11 to enter the battery cell 11 and an outlet element capable of discharging substances inside the battery cell 11 to the exterior of the battery cell 11. Both the inlet element and the outlet element are connected with the battery cell 11.

In one embodiment, the inlet element and the outlet element are respectively connected to different positions on the battery cell 11.

As shown in FIG. 1 and FIG. 2, in one embodiment, the inlet element includes a cell inlet pipe 141, the outlet element includes a cell outlet pipe 142, and the cell inlet pipe 141 and the cell outlet pipe 142 are respectively connected to different positions on the battery cell 11.

As shown in FIG. 1 and FIG. 2, in one embodiment, the cell inlet pipe 141 is connected to the bottom position of the battery cell 11, and the cell outlet pipe 142 is connected to the top position of the battery cell 11.

As shown in FIG. 1 and FIG. 2, in one embodiment, a one-way valve 17 is arranged on the cell inlet pipe 141 and/or the cell outlet pipe 142. The one-way valve 17 can be a one-way solenoid valve, or an ordinary straight-through or right-angle one-way valve.

Specifically, by setting a one-way valve 17 on the cell inlet pipe 141 and the cell outlet pipe 142, the present invention adopts the one-way flow design when filling electrolyte into the battery cell 11, so as to strictly control the flow direction of the electrolyte during the electrolyte filling process, and ensure the stability and consistency of the electrolyte capacity in each battery cell 11 after the electrolyte filling is completed. The one-way valve 17 on the cell inlet pipe 141 only allows the electrolyte to flow into the battery cell 11 from the cell inlet pipe 141, and the one-way valve 17 on the cell outlet pipe 142 only allows the electrolyte and gas to flow out of the battery cell 11 to the cell outlet pipe 142. When the coolant is injected into the battery cell 11, the one-way valve 17 on the cell inlet pipe 141 only allows the coolant to flow into the battery cell 11 from the cell inlet pipe 141, and the one-way valve 17 on the cell outlet pipe 142 only allows the heat, flame and combustible gas generated inside the battery cell 11 to flow out to the cell outlet pipe 142 without backflow.

As shown in FIG. 1 and FIG. 2, in one embodiment, the one-way valve 17 is arranged on the cell inlet pipe 141 close to the battery cell 11, and/or the one-way valve 17 is arranged on the cell outlet pipe 142 close to the battery cell 11.

In one embodiment, the one-way valve 17 is connected with the battery cell 11 through a hose (not shown).

As shown in FIG. 1 and FIG. 2, in one embodiment, at least a portion of the cell inlet pipe 141 is hose, and/or at least a portion of the cell outlet pipe 142 is hose.

Specifically, the cell inlet pipe 141 and the cell outlet pipe 142 can be a hose as a whole, or a combination of hard pipe and hose (i.e., a portion of the cell inlet pipe 141 or the cell outlet pipe 142 is hose and the other portion is hard pipe). By adopting the design of hose connection, the present invention can effectively eliminate the tolerance of design and assembly, facilitate the automatic installation of pipes and improve the reliability of pipe design because the hose connection design has low requirements for assembly accuracy.

As shown in FIG. 2 and FIG. 6, in one embodiment, an on-off valve 145 is arranged on the cell inlet pipe 141 and/or the cell outlet pipe 142.

Specifically, the on-off valve 145 on the cell inlet pipe 141 of each battery cell 11 is independent and does not affect each other. The on-off valve 145 is in a normally closed state and can be opened and closed independently as required, so as to enable the electrolyte or coolant to enter one or more battery cells 11 independently without affecting other battery cells 11.

In one embodiment, when electrolyte is injected into the battery cell 11, the on-off valve 145 may be a hand valve, a solenoid valve, or the like. In another embodiment, when coolant is injected into the battery cell 11, the on-off valve 145 may be a solenoid valve or the like (because the hand valve does not have the function of automatic opening and closing).

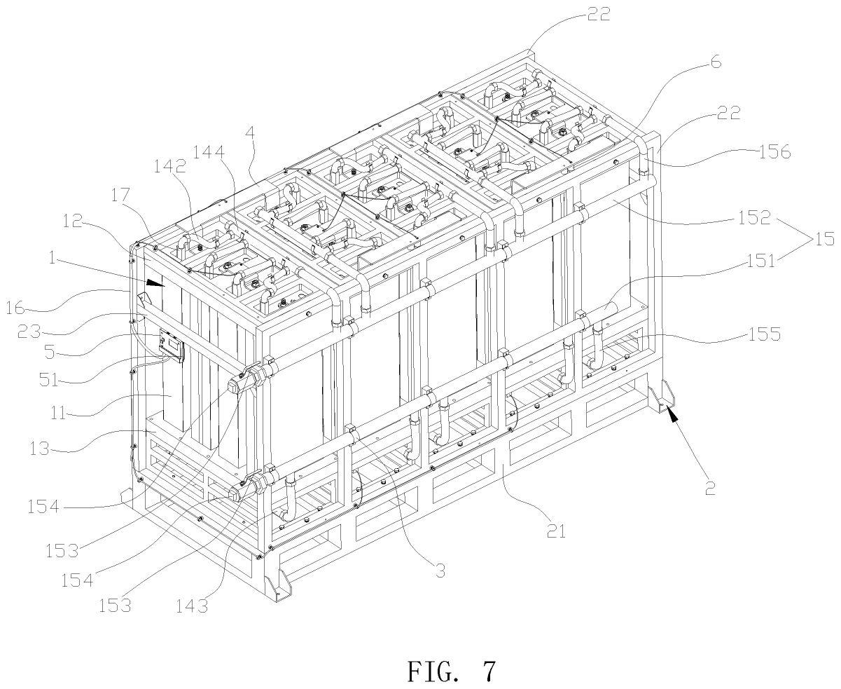

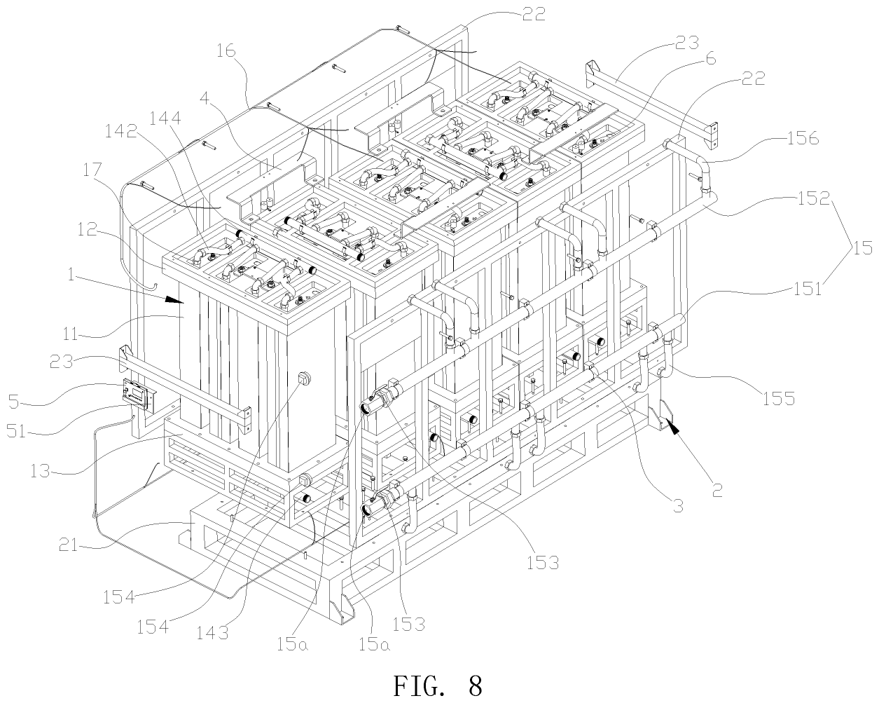

As shown in FIG. 7 and FIG. 8, in one embodiment, the circulation elements further include external pipes 15, the external pipes 15 include an external inlet pipe 151 and an external outlet pipe 152, the external inlet pipe 151 is connected with the cell inlet pipe 141, and the external outlet pipe 152 is connected with the cell outlet pipe 142.

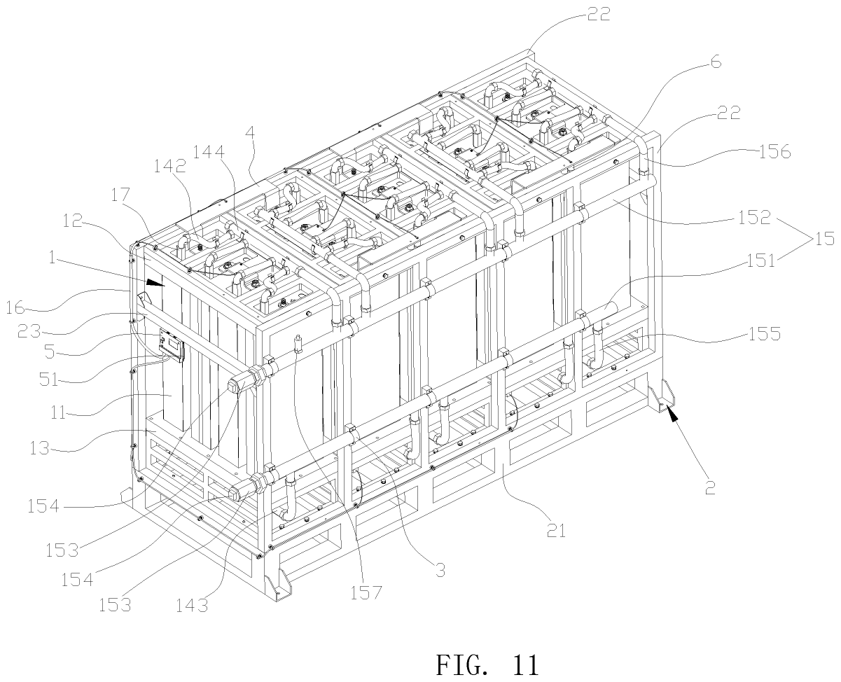

As shown in FIG. 11, in another embodiment, the external outlet pipe 152 is provided with a pressure sensor 157 for monitoring the pressure change in the external outlet pipe 152. When thermal runaway of a battery cell 11 occurs, the temperature and pressure in the battery cell 11 rise and the gas is discharged from the battery cell 11. The gas enters the external outlet pipe 152 after passing through the cell outlet pipe 142. The pressure sensor 157 located on the external outlet pipe 152 can quickly detect the increase of pressure in the pipe and give an alarm. At the same time, the temperature sensor (not shown) located on the battery cell 11 can detect the increase of temperature of the battery cell 11, so as to judge the battery cell 11 occurring with thermal runaway. According to the judged battery cell 11 with thermal runaway, the on-off valve 145 connected with the battery cell 11 is opened, and the coolant flows into the battery cell 11 from the external pipes 15 to cool the battery cell 11. That is, the coolant enters the battery cell 11 for cooling through the external inlet pipe 151 and the cell inlet pipe 141 in sequence, and then is discharged out of the battery cell 11 through the cell outlet pipe 142 and the external outlet pipe 152 in sequence, such that the coolant continuously flows into and out of the battery cell 11, so as to continuously cool the battery cell 11.

As shown in FIG. 7 and FIG. 8, in one embodiment, the external inlet pipe 151 and the external outlet pipe 152 are each provided with an openable valve 153.

As shown in FIG. 7 and FIG. 8, in one embodiment, when electrolyte is injected into the battery cell 11, the openable valve 153 can be a hand valve, a solenoid valve, a one-way valve, or the like. As shown in FIG. 11, in another embodiment, when coolant is injected into the battery cell 11, the openable valve 153 can be a solenoid valve, a one-way valve, or the like (because the hand valve does not have the function of automatic opening and closing).

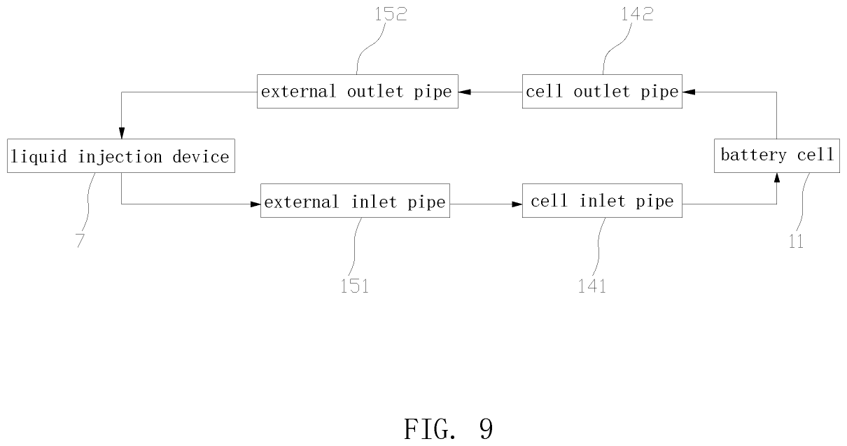

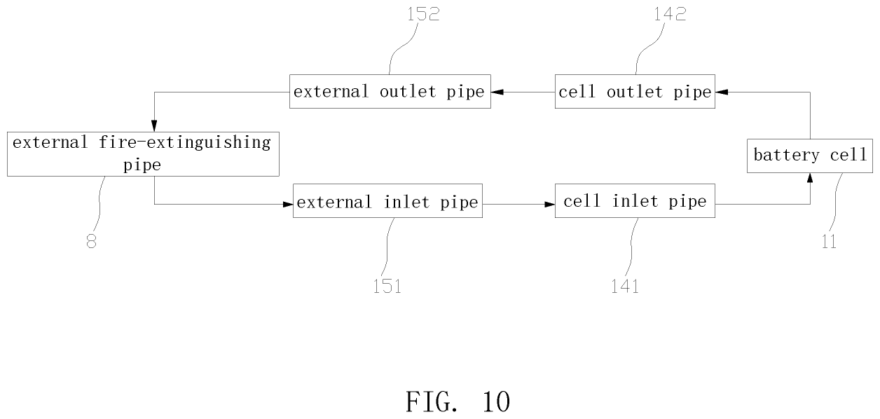

As shown in FIG. 7 and FIG. 8, in one embodiment, both the external inlet pipe 151 and the external outlet pipe 152 have an interface 15a, and the valve 153 is arranged at the interface 15a of the external inlet pipe 151 and the interface 15a of the external outlet pipe 152. When electrolyte is filled into the battery cell 11, the interfaces 15a on the external inlet pipe 151 and the external outlet pipe 152 are connected to a liquid injection device 7 (see FIG. 9 for the liquid injection device 7). When no liquid is injected, the interfaces 15a on the external inlet pipe 151 and the external outlet pipe 152 are each sealed by a first plug 154 so as to seal the interfaces 15a. Optionally, after the liquid injection is completed, the interfaces 15a on the external inlet pipe 151 and the external outlet pipe 152 may also be connected to an external fire-extinguishing pipe 8 (see FIG. 10 for the external fire-extinguishing pipe 8), so as to inject coolant into the battery cell 11 through the external fire-extinguishing pipe 8 after thermal runaway occurs in the battery cell 11.

Specifically, the present invention effectively ensures the sealing performance of the external inlet pipe 151 and the external outlet pipe 152 by adopting the double sealing design of the valve 153 and the first plug 154. When filling electrolyte, the first plug 154 is first removed, then the liquid filling device 7 is connected with the interfaces 15a on the external inlet pipe 151 and the external outlet pipe 152, and then the valves 153 are turned on for liquid filling. After the electrolyte filling is completed, the valves 153 are first turned off, then the liquid filling device 7 is disconnected from the interfaces 15a, and finally the first plugs 154 are installed.

As shown in FIG. 7 and FIG. 8, in one embodiment, the external inlet pipe 151 is arranged at the bottom of the battery cell 11, and the external outlet pipe 152 is arranged at the top of the battery cell 11.

The embodiment of the present invention further provides a battery unit 1, including at least one or more of the battery cells 11. The circulation elements include an inlet element and an outlet element, the inlet element includes a cell inlet pipe 141, the outlet element includes a cell outlet pipe 142, and the cell inlet pipe 141 and the cell outlet pipe 142 are respectively connected to different positions on the battery cell 11. The circulation elements further include external pipes 15, the external pipes 15 include an external inlet pipe 151 and an external outlet pipe 152, the external inlet pipe 151 is connected with the cell inlet pipe 141, and the external outlet pipe 152 is connected with the cell outlet pipe 142.

As shown in FIG. 1, FIG. 2 and FIG. 7, another embodiment of the present invention further provides a battery unit 1, including a plurality of battery cells 11 described above. The circulation elements include an inlet element and an outlet element, the inlet element includes a cell inlet pipe 141, the outlet element includes a cell outlet pipe 142, and the cell inlet pipe 141 and the cell outlet pipe 142 are respectively connected to different positions on the battery cell 11. The circulation elements further include external pipes 15, the external pipes 15 include an external inlet pipe 151 and an external outlet pipe 152, the external inlet pipe 151 is connected with the cell inlet pipe 141, and the external outlet pipe 152 is connected with the cell outlet pipe 142. The battery unit 1 further includes a cell inlet main pipe 143 and a cell outlet main pipe 144. The cell inlet pipes 141 on the plurality of battery cells 11 are firstly collectively connected to the cell inlet main pipe 143 and then connected to the external inlet pipe 151. The cell outlet pipes 142 on the plurality of battery cells 11 are firstly collectively connected to the cell outlet main pipe 144 and then connected to the external outlet pipe 152.

As shown in FIG. 7 and FIG. 8, in one embodiment, the external pipes 15 further include first external branch pipes 155 and second external branch pipes 156. One end of each first external branch pipe 155 is connected with the cell inlet main pipe 143 of a corresponding battery unit 1, and the other end of each first external branch pipe 155 is connected with the external inlet pipe 151. One end of each second external branch pipe 156 is connected to the cell outlet main pipe 144 of a corresponding battery unit 1, and the other end of each second external branch pipe 156 is connected to the external outlet pipe 152.

As shown in FIG. 7 and FIG. 8, in one embodiment, the first external branch pipes 155 and/or the second external branch pipes 156 are hoses.

Specifically, as shown in FIGS. 7 to 9, when electrolyte is injected into the battery cell 11, the electrolyte flows out of the liquid injection device 7 and then is injected into the battery cell 11 through the external inlet pipe 151 and the cell inlet pipe 141 in sequence, while the air and excess electrolyte inside the battery cell 11 are discharged out of the battery cell 11 and returned to the liquid injection device 7 through the cell outlet pipe 142 and the external outlet pipe 152 in sequence. As shown in FIG. 7 and FIG. 10, when the coolant is injected into a battery cell 11 in which thermal runaway occurs, the coolant flows out of the external fire-extinguishing pipe 8 and then is injected into the battery cell 11 through the external inlet pipe 151 and the cell inlet pipe 141 in sequence, while the coolant, combustible gas and other substances inside the battery cell 11 are discharged out of the battery cell 11 and returned to the external fire-extinguishing pipe 8 through the cell outlet pipe 142 and the external outlet pipe 152 in sequence.

As shown in FIG. 1 and FIG. 2, in one embodiment, the cell inlet main pipe 143 and the cell outlet main pipe 144 are opened at both ends, so as to facilitate connection with the external inlet pipe 151 and the external outlet pipe 152. After one end of the cell inlet main pipe 143 is connected with the external inlet pipe 151, the other end of the cell inlet main pipe 143 is sealed with a second plug 191. After one end of the cell outlet main pipe 144 is connected with the external outlet pipe 152, the other end of the cell outlet main pipe 144 is sealed with a second plug 191.

As shown in FIG. 1 and FIG. 2, in one embodiment, the battery unit 1 further includes a protection bracket 12 and a support bracket 13. The protection bracket 12 and the support bracket 13 are respectively arranged at opposite ends of each battery cell 11. The cell outlet pipe 142 is fixed on the protection bracket 12 through a fixing buckle 192, and the cell inlet pipe 141 is fixed on the support bracket 13 through a fixing buckle 192.

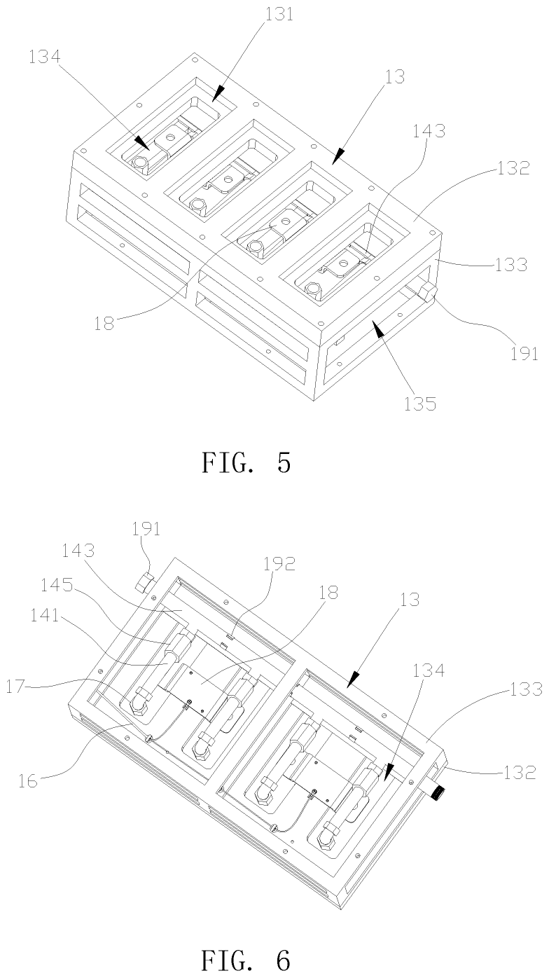

As shown in FIG. 4 and FIG. 5, in one embodiment, the protection bracket 12 is provided with at least one first receiving groove 121, the support bracket 13 is provided with at least one second receiving groove 131, and the opposite ends of each battery cell 11 are located in a corresponding first receiving groove 121 and a corresponding second receiving groove 131 respectively, so as to facilitate the positioning, installation and fixation of the battery cell 11.

As shown in FIG. 4 and FIG. 5, in one embodiment, there are a plurality of first receiving grooves 121 and a plurality of second receiving grooves 131, the plurality of first receiving grooves 121 are arranged in the protection bracket 12 at intervals, and the plurality of second receiving grooves 131 are arranged in the support bracket 13 at intervals.

As shown in FIG. 1 and FIG. 2, in one embodiment, the battery cell 11 extends along a vertical direction, that is, the battery cell 11 is placed vertically. The liquid holes 111, electrodes (not shown) and other components of the battery cell 11 are arranged at the upper and lower ends of the battery cell 11. The protection bracket 12 is arranged above the battery cell 11, and the protection bracket 12 is fixed with the top of the battery cell 11. The support bracket 13 is arranged below the battery cell 11, and the support bracket 13 is fixed with the bottom of the battery cell 11. The cell outlet pipe 142 is connected to the liquid hole 111 at the top of the battery cell 11, and the cell inlet pipe 141 is connected to the liquid hole 111 at the bottom of the battery cell 11. When injecting liquid into the battery cell 11, the electrolyte flows into the battery cell 11 from the liquid hole 111 at the bottom of the battery cell 11 through the cell inlet pipe 141, and the excess electrolyte and gas in the battery cell 11 are discharged from the liquid hole 111 at the top of the battery cell 11 through the cell outlet pipe 142.

Specifically, the support bracket 13 mainly plays a load-bearing role (i.e., bearing the weight of the battery cell 11) and protects the electrodes, copper bars, wires, liquid injection pipes and other components located at the bottom of the battery cell 11. The protection bracket 12 mainly protects the electrodes, copper bars, wires, liquid injection pipes and other components located on the top of the battery cell 11. The protection bracket 12 and the support bracket 13 cooperate with each other to fix the battery cell 11, so as to facilitate the subsequent installation and fixation of the battery cell 11.

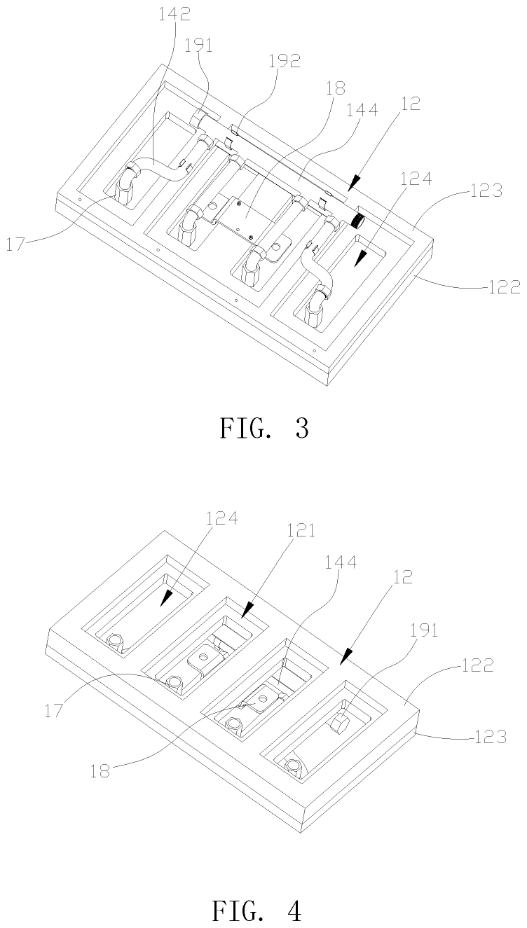

As shown in FIG. 3 and FIG. 4, in one embodiment, the protection bracket 12 includes a protection plate 122 and a protection cover 123. The protection plate 122 is connected with the battery cell 11, the protection cover 123 is connected with the protection plate 122 and located on one side of the protection plate 122 away from the battery cell 11, the first receiving groove 121 is arranged in the protection plate 122, and the cell outlet pipe 142 is fixed on the protection cover 123.

As shown in FIG. 5 and FIG. 6, in one embodiment, the support bracket 13 includes a support tray 132 and a fixing frame 133. The support tray 132 is connected with the battery cell 11, the fixing frame 133 is connected with the support tray 132 and located on one side of the support tray 132 away from the battery cell 11, the second receiving groove 131 is arranged in the support tray 132, and the cell inlet pipe 141 is fixed on the fixing frame 133.

In one embodiment, the protection plate 122 and the support tray 132 are made of insulating material.

Specifically, the main functions of the fixing frame 133 include: (1) for providing structural strength for the battery unit 1 and bearing the weight of the battery cells 11 and related accessories; (2) for connecting the battery unit 1 to a battery cluster bracket 2 (the battery cluster bracket 2 is described in detail below); (3) for protecting the electrodes, copper bars, wires, liquid injection pipes and other components. The protection cover 123 mainly provides structural strength for the protection bracket 12 and facilitates the fixed connection between the protection bracket 12 and a side connection frame 22 (the side connection frame 22 is described in detail below). The protection plate 122 and the support tray 132 mainly function for insulation, and position and fix the battery cells 11 simultaneously. In other embodiments, the protection plate 122 and the protection cover 123 may also be integrated into an integrated structure, and the support tray 132 and the fixing frame 133 may also be integrated into an integrated structure.

As shown in FIG. 3 and FIG. 4, in one embodiment, the protection bracket 12 is provided with first through holes 124, the cell outlet pipe 142 is located above the protection bracket 12, and the cell outlet pipe 142 passes through a corresponding first through hole 124 and is connected with the top of the battery cell 11. As shown in FIG. 5 and FIG. 6, the support bracket 13 is provided with second through holes 134, the support bracket 13 is provided with a receiving chamber 135, the cell inlet pipe 141 is located in the receiving chamber 135, and the cell inlet pipe 141 passes through a corresponding second through hole 134 and is connected with the bottom of the battery cell 11.

As shown in FIG. 7 and FIG. 8, the embodiment of the present invention further provides a battery cluster, including at least one battery unit 1 described above.

As shown in FIG. 7 and FIG. 8, in one embodiment, the battery cluster further includes a battery cluster bracket 2, and the battery unit 1 is arranged on the battery cluster bracket 2.

As shown in FIG. 7 and FIG. 8, in one embodiment, the battery cluster bracket 2 includes a bottom support frame 21 and a side connection frame 22. The bottom support frame 21 is arranged below the battery unit 1, and the side connection frame 22 is fixedly connected with the bottom support frame 21 and arranged on at least one side of the battery cluster. The support bracket 13 of each battery unit 1 is fixedly connected with the bottom support frame 21, and the protection bracket 12 of each battery unit 1 is fixedly connected with the side connection frame 22. The external inlet pipe 151 and the external outlet pipe 152 are fixed on the side connection frame 22.

As shown in FIG. 7 and FIG. 8, in one embodiment, the support bracket 13 is fixedly connected with the bottom support frame 21 through pins and/or bolts, and the protection bracket 12 is fixedly connected with the side connection frame 22 through bolts, so as to firmly fix the battery cells 11 on the battery cluster bracket 2. The external inlet pipe 151 and the external outlet pipe 152 are fixed to the side connection frame 22 by pipe clamps 3.

As shown in FIG. 7 and FIG. 8, in one embodiment, the number of the side connection frame 22 is two, and the two side connection frames 22 are respectively arranged on the opposite sides of the battery cluster. The battery cluster bracket 2 further includes two side connection beams 23 arranged on the other opposite sides of the battery cluster, and both ends of each side connection beam 23 are respectively connected with the two side connection frames 22.

As shown in FIG. 1, FIG. 2 and FIG. 7, in one embodiment, two adjacent battery cells 11 in each battery unit 1 are connected in series through a first electrical connector 18. As shown in FIG. 7 and FIG. 8, two adjacent battery units 1 in each battery cluster are connected in series through a second electrical connector 4, wherein the second electrical connector 4 is insulated from the protection bracket 12 through an insulating column 6. The battery cluster further includes temperature and voltage detecting cables 16, wherein the temperature and voltage detecting cables 16 are connected with the first electrical connector 18 and the second electrical connector 4 for sampling the temperature and voltage of the battery cells 11.

In one embodiment, the first electrical connector 18 and the second electrical connector 4 are copper bars. Of course, the first electrical connector 18 and the second electrical connector 4 may also be wires or other electrical connectors.

As shown in FIG. 7 and FIG. 8, in one embodiment, the battery cluster further includes a battery management unit 5 and a mounting frame 51. The battery management unit 5 is mounted on the mounting frame 51, and the mounting frame 51 is fixed on the battery cluster bracket 2. The battery management unit 5 is connected with the first electrical connector 18 and the second electrical connector 4 through the temperature and voltage detecting cables 16. The battery management unit 5 is used to manage each battery unit 1 in the battery cluster, collect and balance the voltage and temperature of each battery cell 11 in the battery unit 1, and communicate with other battery clusters in a battery system and with an upper-level processing system.

In one embodiment, the number of the battery cells 11 in each battery unit 1 and the number of the battery cells 1 in each battery cluster can be flexibly configured according to the requirements of voltage and capacity.

The embodiment of the present invention further provides a battery cell liquid injection method for injecting electrolyte into the interior of the battery cell 11. The battery cell liquid injection method includes:
providing circulation elements on the battery cell 11, wherein the circulation elements include an inlet element and an outlet element, the inlet element includes a cell inlet pipe 141, the outlet element includes a cell outlet pipe 142, and the cell inlet pipe 141 and the cell outlet pipe 142 are respectively connected to different positions on the battery cell 11;
connecting the liquid injection device 7 with the cell inlet pipe 141 and the cell outlet pipe 142, using the liquid injection device 7 to inject electrolyte into the interior of the battery cell 11 through the cell inlet pipe 141, and discharging the air and excess electrolyte inside the battery cell 11 back into the liquid injection device 7 through the cell outlet pipe 142; and
disconnecting the liquid injection device 7 from the cell inlet pipe 141 and the cell outlet pipe 142 after the electrolyte injection is completed.

In one embodiment, a one-way valve 17 is arranged on the cell inlet pipe 141 and/or the cell outlet pipe 142. The battery cell liquid injection method further includes:
using the one-way valve 17 to control the one-way flow of the electrolyte when the electrolyte is injected into the interior of the battery cell 11.

The embodiment of the present invention further provides a battery cell liquid injection method for injecting coolant into the interior of a battery cell 11 in which thermal runaway occurs.

The battery cell liquid injection method includes:
providing circulation elements on the battery cell 11, wherein the circulation elements include an inlet element and an outlet element, the inlet element includes a cell inlet pipe 141, the outlet element includes a cell outlet pipe 142, and the cell inlet pipe 141 and the cell outlet pipe 142 are respectively connected to different positions on the battery cell 11;
connecting the external fire-extinguishing pipe 8 with the cell inlet pipe 141 and the cell outlet pipe 142, using the external fire-extinguishing pipe 8 to inject coolant into the interior of the battery cell 11 through the cell inlet pipe 141, and discharging the coolant inside the battery cell 11 back into the external fire-extinguishing pipe 8 through the cell outlet pipe 142, so as to continuously cool the battery cell 11; and
disconnecting the external fire-extinguishing pipe 8 from the cell inlet pipe 141 and the cell outlet pipe 142 after cooling the battery cell 11, or do not disconnect the external fire-extinguishing pipe 8 from the cell inlet pipe 141 and the cell outlet pipe 142 in order to continue to use the external fire-extinguishing pipe 8 to cool the battery cell 11 with thermal runaway.

In one embodiment, a one-way valve 17 is arranged on the cell inlet pipe 141 and/or the cell outlet pipe 142. The battery cell liquid injection method further includes:
using the one-way valve 17 to control the one-way flow of the coolant when the coolant is injected into the interior of the battery cell 11.

The embodiment of the present invention further provides a battery cluster liquid injection method for injecting electrolyte into the interior of the battery cells 11. The battery cluster liquid injection method includes:
assembling at least one battery unit 1 together to form a battery cluster, wherein the battery unit 1 includes at least one battery cell 11, the battery cell 11 is provided with circulation elements, the circulation elements include an inlet element and an outlet element, the inlet element includes a cell inlet pipe 141, the outlet element includes a cell outlet pipe 142, the cell inlet pipe 141 and the cell outlet pipe 142 are respectively connected to different positions on the battery cell 11; the circulation elements further include external pipes 15, the external pipes 15 include an external inlet pipe 151 and an external outlet pipe 152, the external inlet pipe 151 is connected with the cell inlet pipe 141, and the external outlet pipe 152 is connected with the cell outlet pipe 142;
connecting the liquid injection device 7 with the external inlet pipe 151 and the external outlet pipe 152, using the liquid injection device 7 to inject electrolyte into the interior of each battery cell 11 in each battery unit 1 through the external inlet pipe 151 and the cell inlet pipe 141 in sequence, and discharging the air and excess electrolyte inside the battery cell 11 back into the liquid injection device 7 through the cell outlet pipe 142 and the external outlet pipe 152 in sequence; and
disconnecting the liquid injection device 7 from the external inlet pipe 151 and the external outlet pipe 152 after the electrolyte injection is completed.

In one embodiment, a one-way valve 17 is arranged on the cell inlet pipe 141 and/or the cell outlet pipe 142. The battery cluster liquid injection method further includes:
using the one-way valve 17 to control the one-way flow of the electrolyte when the electrolyte is injected into the interior of the battery cells 11.

The embodiment of the present invention further provides a battery cluster liquid injection method for injecting coolant into the interior of a battery cell 11 in which thermal runaway occurs.

The battery cluster liquid injection method includes:
assembling at least one battery unit 1 together to form a battery cluster, wherein the battery unit 1 includes at least one battery cell 11, the battery cell 11 is provided with circulation elements, the circulation elements include an inlet element and an outlet element, the inlet element includes a cell inlet pipe 141, the outlet element includes a cell outlet pipe 142, the cell inlet pipe 141 and the cell outlet pipe 142 are respectively connected to different positions on the battery cell 11; the circulation elements further include external pipes 15, the external pipes 15 include an external inlet pipe 151 and an external outlet pipe 152, the external inlet pipe 151 is connected with the cell inlet pipe 141, and the external outlet pipe 152 is connected with the cell outlet pipe 142;
connecting the external fire-extinguishing pipe 8 with the external inlet pipe 151 and the external outlet pipe 152, using the external fire-extinguishing pipe 8 to inject coolant into the interior of the battery cell 11 with thermal runaway through the external inlet pipe 151 and the cell inlet pipe 141 in sequence, and discharging the coolant inside the battery cell 11 with thermal runaway back into the external fire-extinguishing pipe 8 through the cell outlet pipe 142 and the external outlet pipe 152 in sequence, so as to continuously cool the battery cell 11 with thermal runaway; and
disconnecting the external fire-extinguishing pipe 8 from the external inlet pipe 151 and the external outlet pipe 152 after cooling the battery cell 11 with thermal runaway, or do not disconnect the external fire-extinguishing pipe 8 from the external inlet pipe 151 and the external outlet pipe 152 in order to continue to use the external fire-extinguishing pipe 8 to cool the battery cell 11 with thermal runaway.

In one embodiment, a one-way valve 17 is arranged on the cell inlet pipe 141 and/or the cell outlet pipe 142. The battery cluster liquid injection method further includes:
using the one-way valve 17 to control the one-way flow of the coolant when the coolant is injected into the interior of the battery cell 11 with thermal runaway.

The battery cell 11, the battery unit 1 and the battery cluster provided by the embodiments of the present invention have the following advantages.
(1) The battery cell 11 is carried with its own cell inlet pipe 141 and cell outlet pipe 142. The battery cell 11 is not injected with electrolyte in the process of production, transportation and assembly, and the electrolyte is injected into the battery cell 11 after the installation of the battery cluster. Therefore, it is not charged during transportation and installation of the battery cell, battery unit or battery cluster, so as to eliminate the safety risk in the process of transportation and installation.
(2) Since the battery cells 11 are not injected with electrolyte and the battery cluster is not charged during transportation and installation of the battery cluster, the battery cluster can be transported as a whole, that is, the battery cluster can be transported to the site after assembly, so as to eliminate the field assembly of the battery cluster and improve transportation safety and convenience; meanwhile, there is only the assembly between the battery cluster and the battery cluster on site, and the battery cluster is injected after being assembled to form a battery system on site, so that the on-site installation is safe and convenient.
(3) The battery cell 11 is carried with its own cell inlet pipe 141 and cell outlet pipe 142. The battery cell 11 can be filled with electrolyte as needed to maintain good performance of the battery cell 11, improve the service life of the battery cell 11, solve the problem that the battery cell 11 cannot be maintained, and facilitate the later maintenance and management of the battery cell 11.
(4) The external outlet pipe 152 is provided with a pressure sensor 157 to monitor the pressure change in the external outlet pipe 152, which can detect and quickly intervene to control the thermal runaway in the second stage of thermal runaway, so as to control the thermal runaway more quickly and efficiently; meanwhile, the cell inlet pipe 141 and the cell outlet pipe 142 are directly connected with the battery cell 11, when thermal runaway occurs in the battery cell 11, the coolant can be quickly injected into the battery cell 11 through the cell inlet pipe 141, and the heat, flame and combustible gas generated inside the battery cell 11 can be quickly discharged out of the battery cell 11 through the cell outlet pipe 142 to extinguish the fire and reduce the internal temperature of the battery cell 11, thereby preventing the deterioration of the battery cell 11 with thermal runaway from proceeding towards the next stage, and improving the safety performance of the battery cell 11.
(5) An on-off valve 145 is arranged on the cell inlet pipe 141. The on-off valve 145 on the cell inlet pipe 141 of each battery cell 11 is independent of each other and does not affect each other. The on-off valve 145 can be opened and closed independently as required to enable the coolant to enter one or more battery cells 11 independently without affecting other battery cells 11, thereby reducing the cost loss.
(6) By adopting the design of hose connection, because the hose connection design has low requirements for assembly accuracy, it can effectively eliminate the design and assembly tolerance, facilitate the automatic installation of pipes and improve the reliability of pipe design.
(7) By adopting the double sealing design of the valve 153 and the first plug 154, it can effectively ensure the sealing performance of the external inlet pipe 151 and the external outlet pipe 152.
(8) By setting a one-way valve 17 on the cell inlet pipe 141 and the cell outlet pipe 142, it adopts the one-way flow design of electrolyte to strictly control the flow direction of electrolyte during electrolyte filling, so as to ensure the stability and consistency of electrolyte capacity in each battery cell 11 after electrolyte filling.
(9) The battery unit 1 is assembled by the battery cells 11, the protection bracket 12 and the support bracket 13. The battery cells 11 are not injected with electrolyte during production, transportation and assembly. The volume and capacity of the battery cells 11 can be set larger and the number of battery cells 11 can be reduced. Therefore, multiple parallel branches of the battery system can be reduced or cancelled, and the battery casing level is omitted (i.e., no battery casing is required). Meanwhile, after the battery units 1 are assembled to form a battery cluster, there is no need to set a high-voltage control box in each battery cluster, so as to greatly reduce the number of electrical parts and structural parts, improve the energy density of the battery units 1 and the battery cluster and the reliability of the operation, and reduce the cost. Moreover, the distance between the battery cells 11 in the battery unit 1 is relatively far, and the heat transferred between them is less, which can effectively prevent multiple battery cells 11 from thermal runaway at the same time.
(10) Since the battery cluster is assembled in the unit of battery units 1, the number of battery cells 11 in each battery unit 1 and the number of battery units 1 in each battery cluster can be flexibly configured, so that the voltage and capacity of the battery cluster can be flexibly configured.
(11) The battery system does not need multiple battery clusters to be connected in parallel, and each battery system only needs to be equipped with a high-voltage control box, so as to improve the service reliability of the battery system, reduce the number of electrical parts and reduce the cost.

The above is only the specific embodiments of the present invention, but the protection scope of the present invention is not limited to this. Any person skilled in the technical field can easily think of changes or replacements within the technical scope disclosed by the present invention, which should be covered by the protection scope of the present invention. Therefore, the protection scope of the present invention shall be defined by the appended claims.

What is claimed is:

1. A battery cell, wherein the battery cell (11) is provided with circulation elements for circulating between inside and outside of the battery cell (11), and the circulation elements are connected with the battery cell (11); substances inside the battery cell (11) are capable of being discharged out of the battery cell (11) through the circulation elements, and substances outside the battery cell (11) are also capable of entering an interior of the battery cell (11) through the circulation elements.

2. The battery cell according to claim 1, wherein the circulation elements comprise an inlet element capable of allowing substances outside the battery cell (11) to enter the battery cell (11) and an outlet element capable of discharging substances inside the battery cell (11) to an exterior of the battery cell (11), both the inlet element and the outlet element are connected with the battery cell (11).

3. The battery cell according to claim 2, wherein the inlet element and the outlet element are respectively connected to different positions on the battery cell (11).

4. The battery cell according to claim 2, wherein the inlet element comprises a cell inlet pipe (141), the outlet element comprises a cell outlet pipe (142), and the cell inlet pipe (141) and the cell outlet pipe (142) are respectively connected to different positions on the battery cell (11).

5. The battery cell according to claim 4, wherein the cell inlet pipe (141) is connected to the bottom position of the battery cell (11), and the cell outlet pipe (142) is connected to the top position of the battery cell (11).

6. The battery cell according to claim 4, wherein an on-off valve (145) and/or a one-way valve (17) are arranged on the cell inlet pipe (141) and/or the cell outlet pipe (142).

7. The battery cell according to claim 6, wherein a one-way valve (17) is arranged on the cell inlet pipe (141) and/or the cell outlet pipe (142); the one-way valve (17) is arranged on the cell inlet pipe (141) close to the battery cell (11), and/or the one-way valve (17) is arranged on the cell outlet pipe (142) close to the battery cell (11).

8. The battery cell according to claim 6, wherein a one-way valve (17) is arranged on the cell inlet pipe (141) and/or the cell outlet pipe (142); the one-way valve (17) is connected with the battery cell (11) through a hose.

9. The battery cell according to claim 4, wherein at least a portion of the cell inlet pipe (141) is hose, and/or at least a portion of the cell outlet pipe (142) is hose.

10. The battery cell according to claim 4, wherein the circulation elements further comprise external pipes (15), the external pipes (15) comprise an external inlet pipe (151) and an external outlet pipe (152), the external inlet pipe (151) is connected with the cell inlet pipe (141), and the external outlet pipe (152) is connected with the cell outlet pipe (142).

11. The battery cell according to claim 10, wherein the external outlet pipe (152) is provided with a pressure sensor (157).

12. The battery cell according to claim 10, wherein the external inlet pipe (151) and the external outlet pipe (152) are each provided with an openable valve (153).

13. The battery cell according to claim 10, wherein the external inlet pipe (151) is arranged at the bottom of the battery cell (11), and the external outlet pipe (152) is arranged at the top of the battery cell (11).

14. A battery unit comprising at least one battery cell (11) according to claim 1, wherein the circulation elements comprise an inlet element and an outlet element, the inlet element comprises a cell inlet pipe (141), the outlet element comprises a cell outlet pipe (142), and the cell inlet pipe (141) and the cell outlet pipe (142) are respectively connected to different positions on the battery cell (11); the circulation elements further comprise external pipes (15), the external pipes (15) comprise an external inlet pipe (151) and an external outlet pipe (152), the external inlet pipe (151) is connected with the cell inlet pipe (141), and the external outlet pipe (152) is connected with the cell outlet pipe (142).

15. The battery unit according to claim 14, wherein there are a plurality of battery cells (11) in the battery unit, the circulation elements comprise an inlet element and an outlet element, the inlet element comprises a cell inlet pipe (141), the outlet element comprises a cell outlet pipe (142), and the cell inlet pipe (141) and the cell outlet pipe (142) are respectively connected to different positions on each battery cell (11); the circulation elements further comprise external pipes (15), the external pipes (15) comprise an external inlet pipe (151) and an external outlet pipe (152), the external inlet pipe (151) is connected with the cell inlet pipe (141), and the external outlet pipe (152) is connected with the cell outlet pipe (142); the battery unit (1) further comprises a cell inlet main pipe (143) and a cell outlet main pipe (144), the cell inlet pipes (141) on the plurality of battery cells (11) are firstly collectively connected to the cell inlet main pipe (143) and then connected to the external inlet pipe (151), and the cell outlet pipes (142) on the plurality of battery cells (11) are firstly collectively connected to the main outlet pipe (144) and then connected to the external outlet pipe (152).

16. The battery unit according to claim 14, wherein the battery unit (1) further comprises a protection bracket (12) and a support bracket (13), the protection bracket (12) and the support bracket (13) are respectively arranged at opposite ends of each battery cell (11), the cell outlet pipe (142) is fixed on the protection bracket (12), and the cell inlet pipe (141) is fixed on the support bracket (13).

17. The battery unit according to claim 16, wherein the protection bracket (12) is provided with at least one first receiving groove (121), the support bracket (13) is provided with at least one second receiving groove (131), and the opposite ends of each battery cell (11) are respectively located in a corresponding first receiving groove (121) and a corresponding second receiving groove (131).

18. The battery unit according to claim 17, wherein the protection bracket (12) comprises a protection plate (122) and a protection cover (123), the protection plate (122) is connected with the battery cell (11), the protection cover (123) is connected with the protection plate (122) and is located on one side of the protection plate (122) away from the battery cell (11), and the first receiving groove (121) is arranged in the protection plate (122), the cell outlet pipe (142) is fixed on the protection cover (123).

19. The battery unit according to claim 17, wherein the support bracket (13) comprises a support tray (132) and a fixing frame (133), the support tray (132) is connected with the battery cell (11), the fixing frame (133) is connected with the support tray (132) and located on one side of the support tray (132) away from the battery cell (11), and the second receiving groove (131) is arranged in the support tray (132), the cell inlet pipe (141) is fixed on the fixing frame (133).

20. A battery cluster comprising at least one battery unit (1) according to claim 14.

21. The battery cluster according to claim 20, wherein the battery cluster further comprises a battery cluster bracket (2), and the battery unit (1) is arranged on the battery cluster bracket (2).

22. The battery cluster according to claim 21, wherein the battery cluster bracket (2) comprises a bottom support frame (21) and a side connection frame (22), and the side connection frame (22) is connected with the bottom support frame (21) and arranged on at least one side of the battery cluster, the support bracket (13) of the battery unit (1) is connected with the bottom support frame (21), and the protection bracket (12) of the battery unit (1) is connected with the side connection frame (22).

23. The battery cluster according to claim 22, wherein the number of the side connection frame (22) is two, and the two side connection frames (22) are respectively arranged on the opposite sides of the battery cluster; the battery cluster bracket (2) further comprises two side connection beams (23) arranged on the other opposite sides of the battery cluster, and both ends of each side connection beam (23) are respectively connected with the two side connection frames (22).
